(19) United States
(12) Patent Application Publication
(10) Pub. No.: US 2014/0122223 A1
(43) Pub. Date: May 1, 2014

(54) ENHANCED ADSERVING METRIC DETERMINATION

(71) Applicant: TRUEFFECT, INC., Westminster, CO (US)

(72) Inventors: Martin Smith, Westminster, CO (US); Ron Hill, Broomfield, CO (US); Greg Neal, Evergreen, CO (US); David Olson, Westminster, CO (US)

(73) Assignee: TRUEFFECT, INC., Westminster, CO (US)

(21) Appl. No.: 13/934,203

(22) Filed: Jul. 2, 2013

Related U.S. Application Data
(60) Provisional application No. 61/671,646, filed on Jul. 13, 2012.

(51) Int. Cl. G06Q 30/02

(52) U.S. Cl. CPC G06Q 30/0246
USPC 705/14.45

(57) ABSTRACT

A user can view creative from multiple locations (same laptop) and multiple devices (work computer, home computer, tablet, smartphone). The user can also adjust their privacy settings on their browser to accept or reject cookies and/or have anti-spam/spyware software that regularly deletes cookies. An enhanced counting method uses first-party cookie technology to track users across access channels and across privacy settings on their browser. The non-acceptance and deletion of cookies causes the accuracy of the traditional third-party cookie calculated reach and frequency calculations to vary widely. First-party cookies reduce this variability but are still subject to non-acceptance or deletion so additional actions need to be taken to provide the opportunity for accurate reports. Additional steps to increase the accuracy of reach and frequency reporting are provided.

### CROSS-REFERENCE TO RELATED APPLICATIONS

This application claims the benefit of U.S. provisional patent application No. 61/671,646, entitled “Enhanced Adserving Metric Determination” and filed Jul. 13, 2012, which is hereby incorporated in its entirety as if it were fully set forth herein.

This application is related to U.S. Pat. No. 7,904,520, granted Mar. 8, 2011, entitled “First Party Advertisement Serving,” which is incorporated herein by reference for all purposes.

### TECHNICAL FIELD

Implementations described herein relate generally to systems, methods, and processes for counting the unique viewers of internet ads. For example, implementations relate to determining whether a single user has been exposed and/or interacted with an ad one or more times from a single or multiple devices (work computer, home computer, tablet, smartphone, etc.) and/or multiple locations (work, home, other). Additionally, reports can be generated that demonstrate how many of the customers of that advertiser don't accept or regularly delete cookies.

### BACKGROUND

Advertising via the Internet continues to grow and evolve at a rapid pace. Internet browser technology has evolved to encompass security and privacy concerns as well as new device extensions. Internet advertising counting methodologies have generally relied on internet cookies to track the users to determine how many times they have been exposed to ads. More specifically, the counting methodologies have generally relied on third-party internet cookie tracking because the vast majority of tracking companies utilize cookies within their own domain to serve internet ads and track the performance. In many cases, information from an advertiser site domain is transferred to the ad server site domain via the third-party cookies to be used for ad targeting purposes. Internet users are becoming increasingly aware of the data transfer and object to the transfer without their knowledge and permission. For example, if you visit www(dot)Domain1(dot)com you will get various third-party cookies set by the Domain1.com advertising and tracking partners as well as many Domain1.com first-party cookies set by their site partners and internal systems. In response, browser makers have enhanced access to cookie controls to enable the user to: 1) block all cookies; 2) block third-party cookies; 3) allow all cookies. Some mobile browsers are set by default to block third-party cookies and only allow first-party cookies. Standard internet advertising practices use third-party cookies to count internet ad exposure as well as the reach and frequency of those exposures. A problem encountered in counting ad views using third-party cookies is that third-party cookies can be blocked or deleted by the browser, secondary programs or users themselves. When the third-party cookies are blocked or deleted, the reach and frequency counting accuracy can be significantly over/understated, respectively. Interestingly, first-party cookie counting is less susceptible to automated cookie blocking and deletion than third-party cookie counting because users are more comfortable with cookies from companies they know and trust. Additionally, automated cookie deletion programs such as anti-spyware programs are focused on known tracking companies and generally leave first-party cookies alone.

The proliferation of digital devices and the emergence of new First-Party only browsers set a trend that limits the effectiveness of traditional third-party measurement techniques and the vendors in the eco-system that rely on them because they have no control over the upstream systems. Studies have consistently shown a rising trend in measurement deficiency—now greater than three times over traditional reach and frequency. The same factors that impact the measurement techniques are also impacting performance measurement—the association of responses to display advertising at similar rates.

### SUMMARY

Due to enhanced privacy concerns, newer internet browsers and anti-spyware products are making it easier for users to control the acceptance and deletion of internet cookies on their browsers. For example, internet browsers can be set to:
1) accept all cookies;
2) reject third-party cookies but accept first-party cookies;
3) reject all cookies.

Internet advertisers use reach to determine how many users have seen their ads for Return on Investment (ROI) calculations.

Reach calculations for third-party cookies as described by the Interactive Advertising Bureau (IAB) Audience Reach Measurement Guidelines Version 1 Dec. 8, 2008, which is incorporated by reference herein in its entirety, are becoming more and more unreliable due to the volatility of third-party internet cookies due to the issues described herein.

First-Party cookies can get rejected or deleted by the browser but are less likely to get deleted because they are associated with a specific advertiser rather than an unknown company or third-parry ad server.

In one implementation, a process to provide reach and/or frequency calculations is provided. In one particular implementation, for example, a multiple-step process successively refines a reach calculation by adding:
1) A User ID;
2) An alternate user ID to the log file and;
2) A user registration ID from an advertiser registration system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTION OF THE DRAWINGS

FIG. 1 illustrates an example ad serving operating environment.

FIG. 2, collectively including each of sub-FIGS. 2A through 2C, is a flow chart of scenarios of browser security settings.

FIG. 3 is a comparison of first-party ad server setup (domain) to third-party ad server setup (domain).

FIG. 4, collectively including each of sub-FIGS. 4A through 4D, has example reports with the data collected and potential charts depicting the path analysis of a user on different devices and across different locations.

FIG. 5 illustrates a general purpose computing system in which various operations described herein may execute.

FIG. 6 illustrates example operations used for determining one or more metrics related to advertisement serving.

FIG. 7 shows an example implementation of an ad serving environment in which a plurality of identifiers are used in targeting an advertisement to be provided to a user.

FIG. 8 shows another example implementation of an ad serving environment in which a browser and/or device fingerprint identifier is used in targeting an advertisement to be provided to a user.

FIG. 9 shows another example implementation of an ad serving environment in which a pixel firing measurement is performed.

### DETAILED DESCRIPTION

U.S. Pat. No. 7,904,520 entitled “First Party Advertisement Serving” issued Mar. 8, 2011 to Neal et al. describes various first-party advertisement serving techniques and is incorporated by reference herein in its entirety. As described herein, these techniques can be useful in improved measurement of advertisement serving, such as determinations of advertisement reach and frequency. Ad counts based on cookies set in the first-party domain of the advertiser, for example, can be used in determining various measurements related to advertisement serving.

While in many instances, a First-Party measurement system may be much less likely as impacted by cookie blockings or deletions as third-party measurement systems, a measurement model is provided that, in one implementation, comprehends systematically a normalized measurement capability as the measurement landscape becomes increasingly challenging.

In some implementations, a model that comprehends one or more factors that impact measurement accuracy and provides advertisers one or more robust and empirical ways to understand performance of their advertising, make effective attribution and media investment decisions is provided. In one implementation, for example, a production validation methodology provides normalized measurement across the following response dimensions:
Reach & Frequency
Media Overlap
Device Overlap
Closed Loop Measurement and Response Attribution

Generally accepted counting practices (Interactive Advertising Bureau (IAB), MMA) use a new/old cookie technique to track users for reach and frequency counting. In this technique, if no cookie is present, a new cookie is set and the impression and reach are counted, but the technique does not look for a previous impression to link for multi-impression tracking. If a cookie is present, however, the cookie's status is changed to old and then the impression and the reach is counted. The technique also looks back in the log files for a previous ad exposure for multi-impression counting. This technique enables an ad serving company to track ad exposure and frequency to a specific browser to allow for strategic ad rotation as well as Return on Investment (ROI) calculations by a publisher site. If cookies are blocked or deleted by any one of the above mentioned processes, the reach numbers will be much higher because new cookies look like unique users and frequency numbers will be understated because it appears that ads are displayed to multiple users not just one. For example, one person that has their browser set to reject cookies seeing the same ad twice in two different internet surfing sessions will be counted as being two people (reach) seeing the add one time each (frequency) whereas they should be counted as one person with a frequency of two.

In one implementation, the flawed standard new/old cookie setting and reach calculation process is supplemented by including the addition of:
1) Identification numbers added to log files of a first-party cookie;
2) ID values set by secondary advertiser site based systems to count ads more accurately in the following scenarios:
   A) Users with a browser set to block or delete cookies or anti-spyware software that does the same;
   B) Users on different devices (computer, tablet, smart phone);
   C) Users at different locations.

### DEFINITIONS

The following identification values are merely examples of values that may be used within one or more systems or processes described herein.

A user identifier (e.g., User_ID) is a standard cookie with an ID set on a browser by an ad server. In one implementation, for example, the user identifier (User_ID) comprises a combination of a server number and a sequence ID generated by an algorithm in each server.

An alternate user identifier (e.g., Alt_User_ID) is provided to a client device (e.g., by TCP/IP communications in conjunction with HTTP headers) and is created in one or more log files (e.g., from an IP address and a user agent string (e.g., operating system, browser brand and version)). In one implementation, for example, the alternate user identifier may include a device and/or browser “fingerprint” that includes information that can be used to identify a device and/or browser in use on the device. Non-limiting information that may be used to assemble a “fingerprint” for the device and/or browser, for example, may include information such as a user agent (including browser type (e.g., Internet Explorer, Chrome, Apple Safari, Firefox, etc., version, operating system), plug in(s) present, fonts, screen resolution, color depth (e.g., 16, 32 bit, etc.), computer settings, Internet Protocol address, MAC address, or other information that can be obtained or derived from the device and/or browser.

A registration identifier (e.g., Registration_ID) is set by one or more site-side systems as a first-party cookie and is read/writeable by the other systems in the First-Party domain space. In one implementation, for example, a Customer Management System (CMS) leverages user registration information to create a cookie with a unique customer identifier.

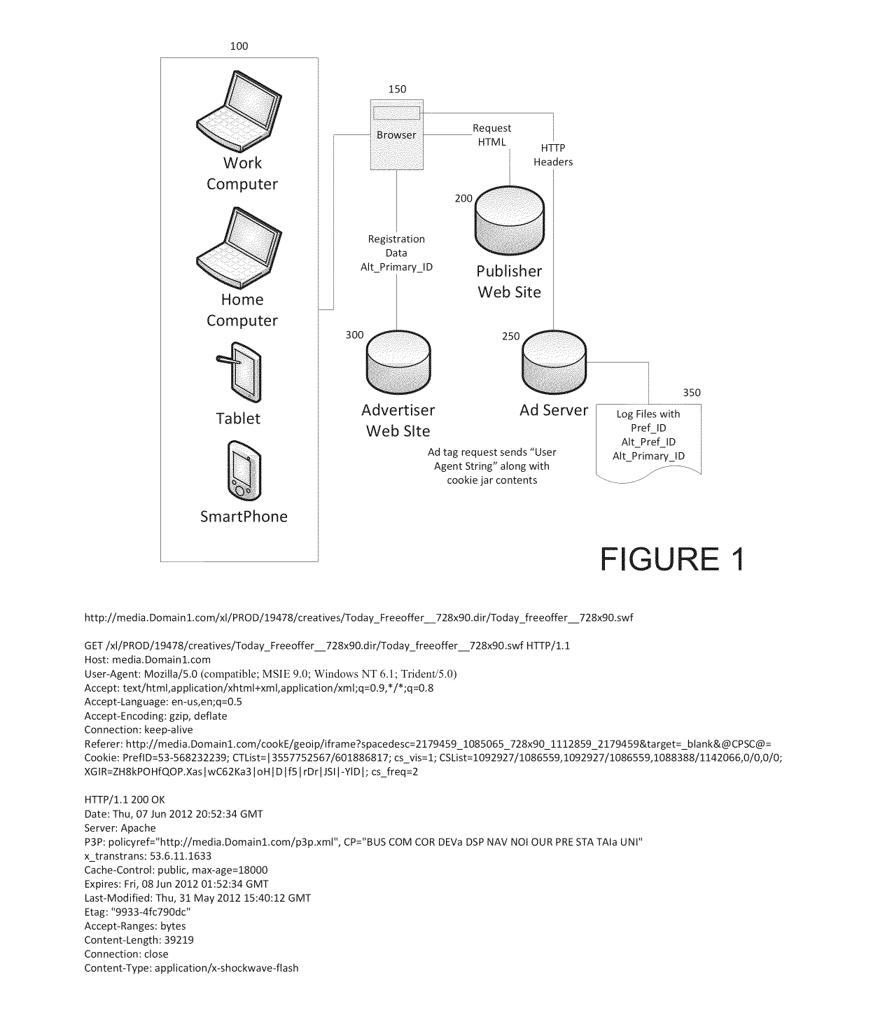

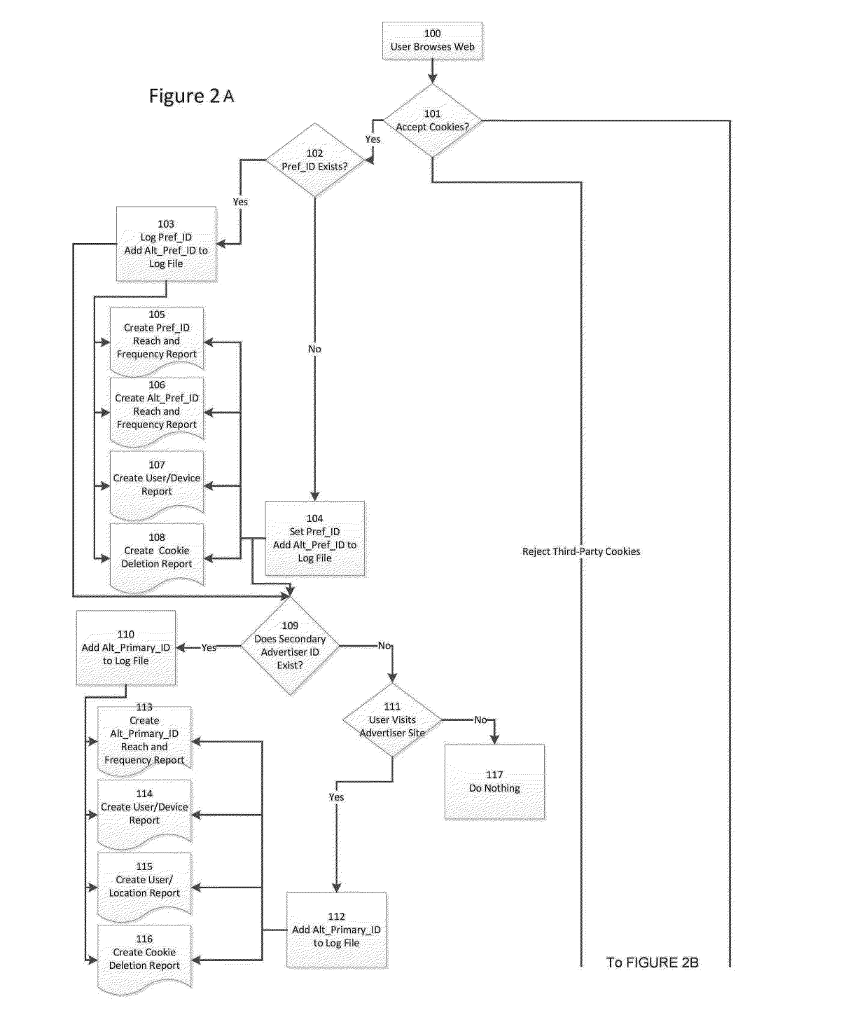

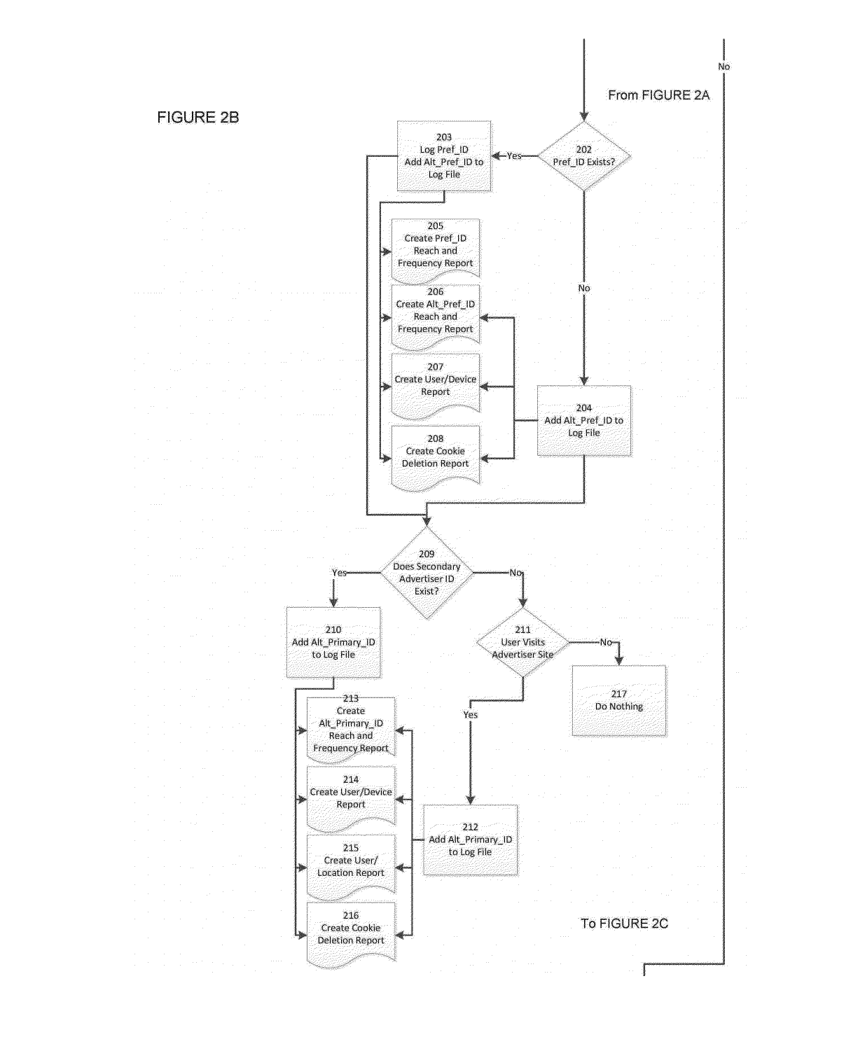

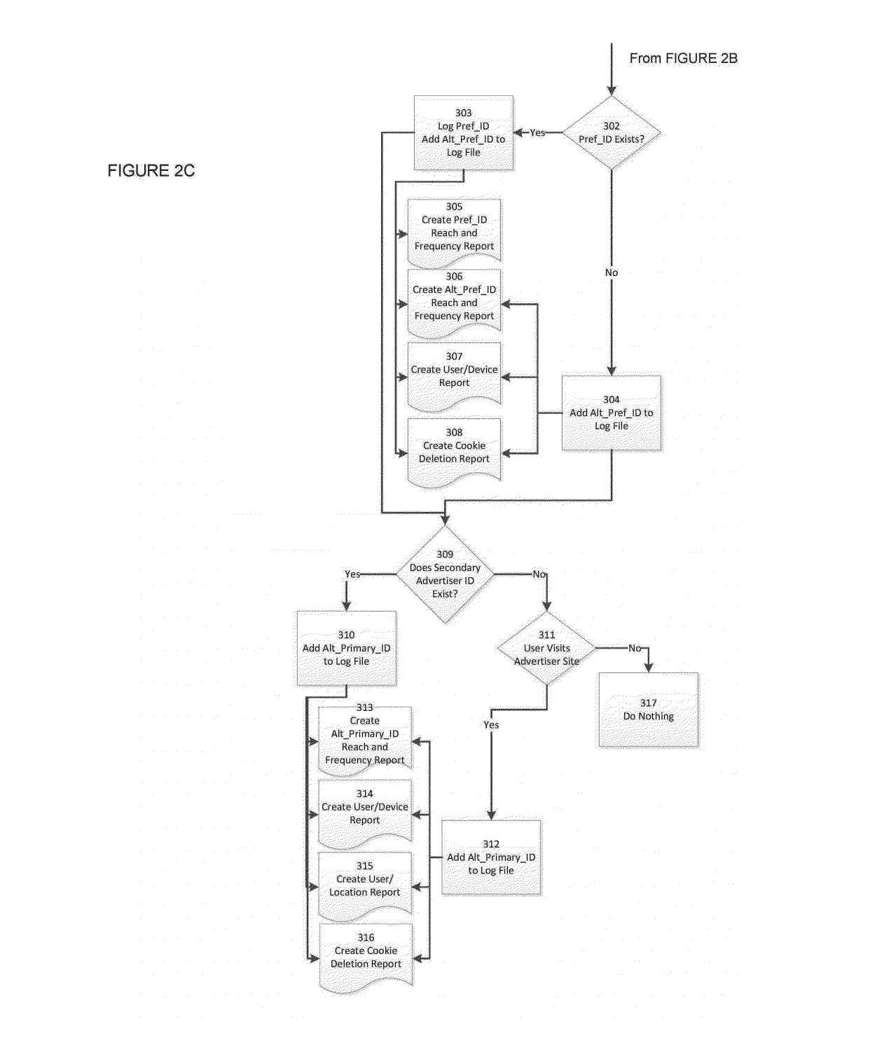

### Scenarios (FIG. 1)

FIG. 1 shows an example ad serving operating environment. In this environment, one or more devices 100, such as but not limited to the work computer, home computer, tablet and smart phone devices shown, connect to various web sites on a network (e.g., the Internet) via a browser 150 operating on the one or more devices 100. The devices 100, for example, may connect to a publisher web site 200, an ad server web site 250 and/or an advertiser web site 300 via the browser 150.

Where a user is a registered user of the advertiser website, for example, the browser may provide registration information data to the advertiser web 300 site to establish credentials when accessing the advertiser web site 300. The registration information data may be used, for example to log in or otherwise inform the web site of the identity of the user and/or establish credentials with the web site.

As described above, the browser 150 may be set at various privacy settings, such as accept all cookies, reject third party cookies but accept first party cookies or reject all cookies.

In one scenario a user has their browser set to accept all cookies (101) and the user already has a User_ID (102). An Alt_User_ID is then created in a log file (103) and the following reports are generated: 1) User_ID reach and frequency reports (105); 2) Alt_User_ID reach and frequency reports (106); 3) User Device reports (107); 4) user cookie deletion reports (108). A subsequent check is made for a Registration_ID (109). If one is found, the Registration_ID is added to the log file (110) and the following reports are generated: 1) Registration_ID reach and frequency reports (113); 2) User Device Reports (114); 3) User Location reports (115); 4) user cookie deletion reports (116).

In another scenario a user has their browser set to accept all cookies and the user already has a User_ID (102). The Alt_User_ID is then created in the log file (103) and the following reports are generated: 1) User_ID reach and frequency reports (105); 2) Alt_User_ID reach and frequency reports (106); 3) User Device reports (107); 4) User cookie deletion reports (108). A subsequent check is made for the Registration_ID (109). If one is not found, nothing happens (117) unless the user visits the advertiser site (111) and gets an Registration_ID in which case the Registration_ID is added to the log file (112) and the following reports are generated: 1) Registration_ID reach and frequency reports (113); 2) User Device Reports (114); 3) User Location reports (115); 4) user cookie deletion reports (116).

In another scenario a user has their browser set to accept all cookies and the user does not have a User_ID (102). The User_ID cookie is set and the Alt_User_ID is then created in the log file (104) and the following reports are generated: 1) User_ID reach and frequency reports (105); 2) Alt_User_ID reach and frequency reports (106); 3) User Device reports (107); 4) Cookie Deletion report (108). A subsequent check is made for the Registration_ID (109). If one is found, the Registration_ID is added to the log file (110) and the following reports are generated: 1) Registration_ID reach and frequency reports (113); 2) User Device Reports (114); 3) User Location reports (115); 4) user cookie deletion reports (116).

In another scenario a user has their browser set to accept all cookies and the user does not have a User_ID. The User_ID cookie is set and the Alt_User_ID is then created in the log file and the following reports are generated: 1) User_ID reach and frequency reports; 2) Alt_User_ID reach and frequency reports; 3) User Device reports. A subsequent check is made for the Registration_ID (109). If one is not found, nothing happens unless the user visits the advertiser site (111) and gets an Registration_ID in which case the Registration_ID is added to the log file (112) and the following reports are generated: 1) Registration_ID reach and frequency reports (113); 2) User Device Reports (114); 3) User Location reports (115); 4) user cookie deletion reports (116).

In another scenario user has their browser set to reject third-party cookies (101). If the User_ID exists (202), the Alt_User_ID is created in the log file (203) and the following reports are generated: 1) User_ID reach and frequency reports (205); 2) Alt_User_ID reach and frequency reports (206); 3) User Device reports (207); 4) Cookie Deletion reports (208). A subsequent check is made for the Registration_ID (209). If one is found, the Registration_ID is added to the log file (210) and the following reports are generated: 1) Registration_ID reach and frequency reports (213); 2) User Device Reports (214); 3) User Location reports (215); 4) user cookie deletion reports (216).

In another scenario user has their browser set to reject third-party cookies (101). If the User_ID exists (202), the Alt_User_ID is created in the log file (203) and the following reports are generated: 1) User_ID reach and frequency reports (205); 2) Alt_User_ID reach and frequency reports (206); 3) User Device reports (207); 4) Cookie Deletion reports (208). A subsequent check is made for the Registration_ID (209). If one is not found nothing happens (217) and gets an Registration_ID in which case the Registration_ID is added to the log file (212) and the following reports are generated: 1) Registration_ID reach and frequency reports (213); 2) User Device Reports (214); 3) User Location reports (215); 4) user cookie deletion reports (216).

In another scenario user has their browser set to reject third-party cookies (101). If the User_ID does not exist (202), the Alt_User_ID is created in the log file (204) and the following reports are generated: 1) User_ID reach and frequency reports (205); 2) Alt_User_ID reach and frequency reports (206); 3) User Device reports (207); 4) Cookie Deletion reports (208). A subsequent check is made for the Registration_ID (209). If one is found, the Registration_ID is added to the log file (210) and the following reports are generated: 1) Registration_ID reach and frequency reports (213); 2) User Device Reports (214); 3) User Location reports (215); 4) user cookie deletion reports (216).

In another scenario a user has their browser set to reject third-party cookies (101). If the User_ID does not exist (202), the Alt_User_ID is created in the log file (204) and the following reports are generated: 1) User_ID reach and frequency reports (205); 2) Alt_User_ID reach and frequency reports (206); 3) User Device reports (207) 4) Cookie Deletion reports (208). A subsequent check is made for the Registration_ID (209). If one is not found, nothing happens unless the user visits the advertiser site (211) and gets an Registration_ID in which case the Registration_ID is added to the log file (212) and the following reports are generated: 1) Registration_ID reach and frequency reports (213); 2) User Device Reports (214); 3) User Location reports (215); 4) user cookie deletion reports (216).

In another scenario user has their browser set to reject all cookies (101). If the User_ID exists (302), the Alt_User_ID is created in the log file (303) and the following reports are generated: 1) User_ID reach and frequency reports (305); 2) Alt_User_ID reach and frequency reports (306); 3) User Device reports (307); 4) Cookie Deletion reports (308). A subsequent check is made for the Registration_ID (309). If one is found, the Registration_ID is added to the log file (310) and the following reports are generated: 1) Registration_ID reach and frequency reports (313); 2) User Device Reports (314); 3) User Location reports (315); 4) user cookie deletion reports (316).

In another scenario user has their browser set to reject all cookies (101). If the User_ID exists (302), the Alt_User_ID is created in the log file (303) and the following reports are generated: 1) User_ID reach and frequency reports (305); 2) Alt_User_ID reach and frequency reports (306); 3) User Device reports (307); 4) Cookie Deletion reports (308). A subsequent check is made for the Registration_ID (309). If one is not found nothing happens (317) and gets an Registration_ID in which case the Registration_ID is added to the log file (312) and the following reports are generated: 1) Registration_ID reach and frequency reports (313); 2) User Device Reports (314); 3) User Location reports (315); 4) user cookie deletion reports (316).

In another scenario user has their browser set to reject all cookies (101). If the User_ID does not exist (302), the Alt_User_ID is created in the log file (304) and the following reports are generated: 1) User_ID reach and frequency reports (305); 2) Alt_User_ID reach and frequency reports (306); 3) User Device reports (307); 4) Cookie Deletion reports (308). A subsequent check is made for the Registration_ID (309). If one is found, the Registration_ID is added to the log file (310) and the following reports are generated: 1) Registration_ID reach and frequency reports (313); 2) User Device Reports (314); 3) User Location reports (315); 4) user cookie deletion reports (316).

In another scenario a user has their browser set to reject all cookies (101). If the User_ID does not exist (302), the Alt_User_ID is created in the log file (304) and the following reports are generated: 1) User_ID reach and frequency reports (305); 2) Alt_User_ID reach and frequency reports (306); 3) User Device reports (307) 4) Cookie Deletion reports (308). A subsequent check is made for the Registration_ID (309). If one is not found, nothing happens unless the user visits the advertiser site (311) and gets an Registration_ID in which case the Registration_ID is added to the log file (312) and the following reports are generated: 1) Registration_ID reach and frequency reports (313); 2) User Device Reports (314); 3) User Location reports (315); 4) user cookie deletion reports (316).

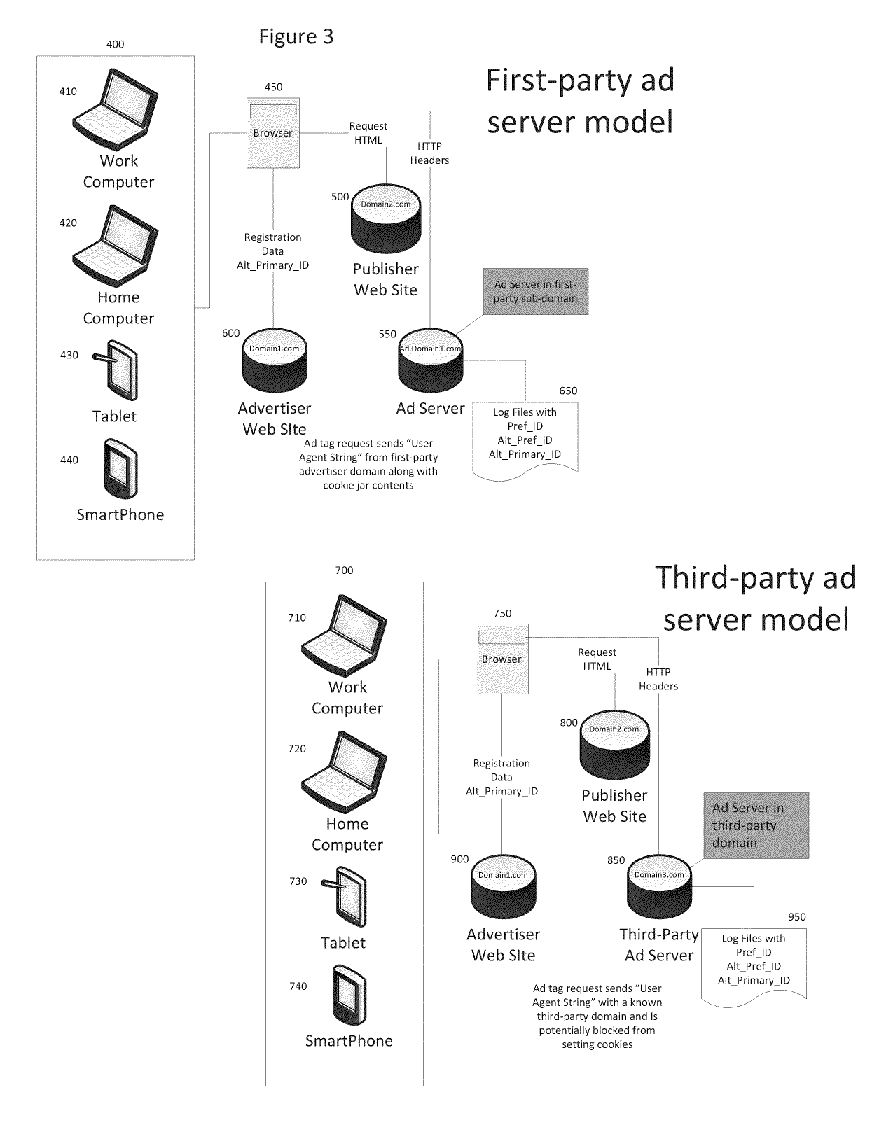

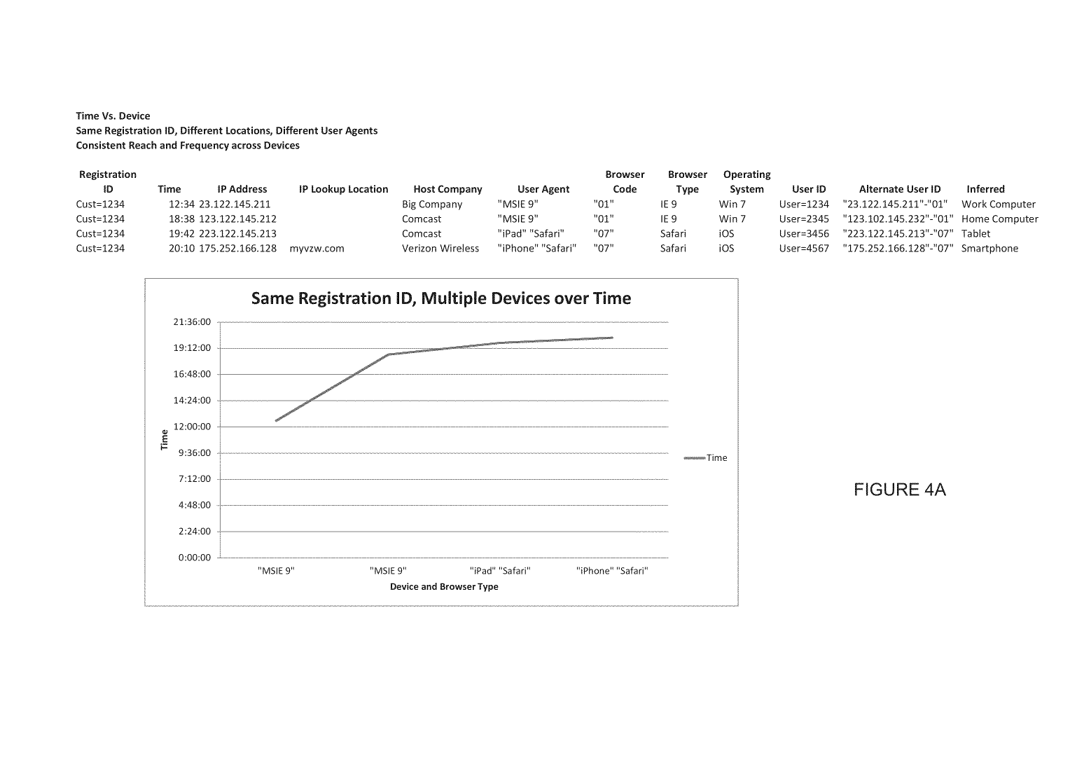

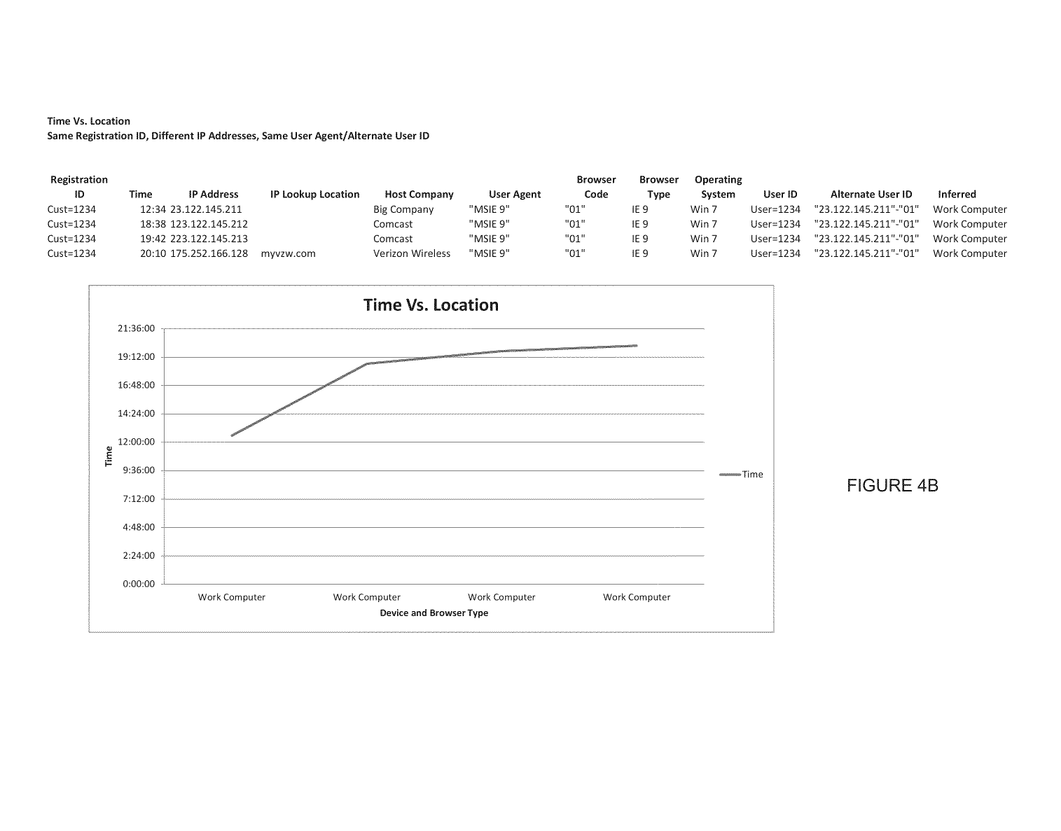

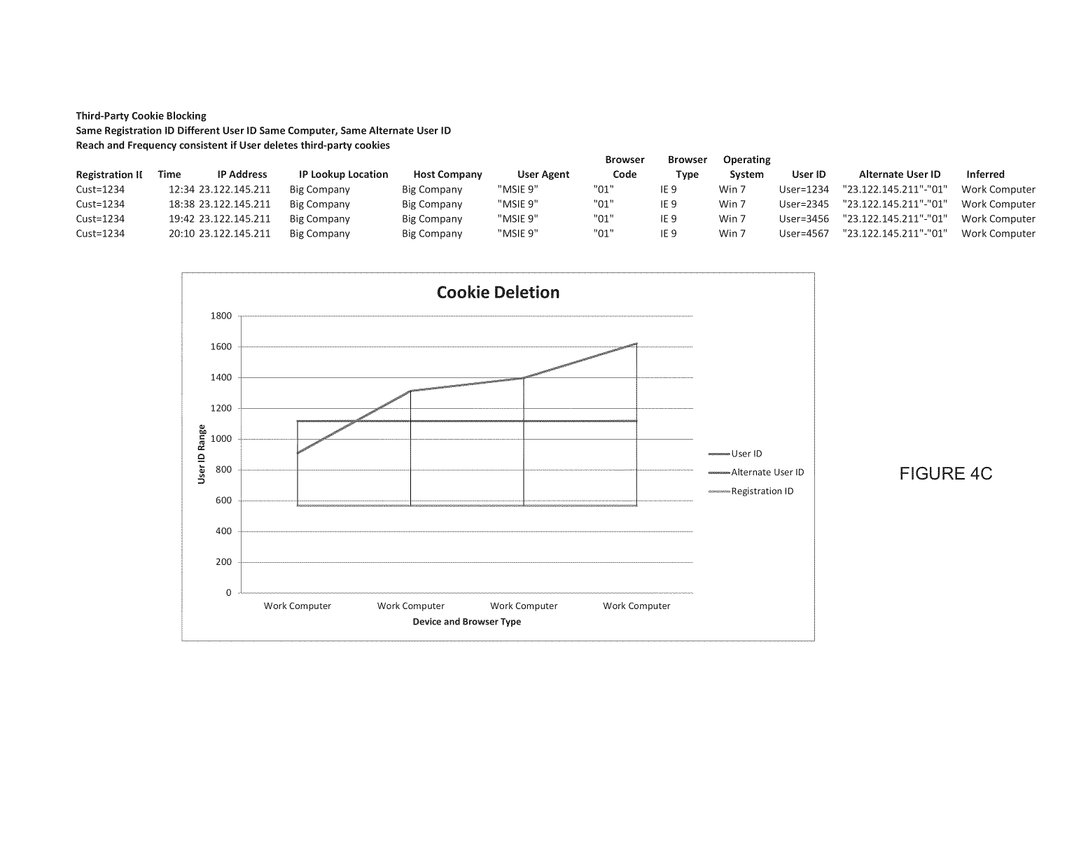

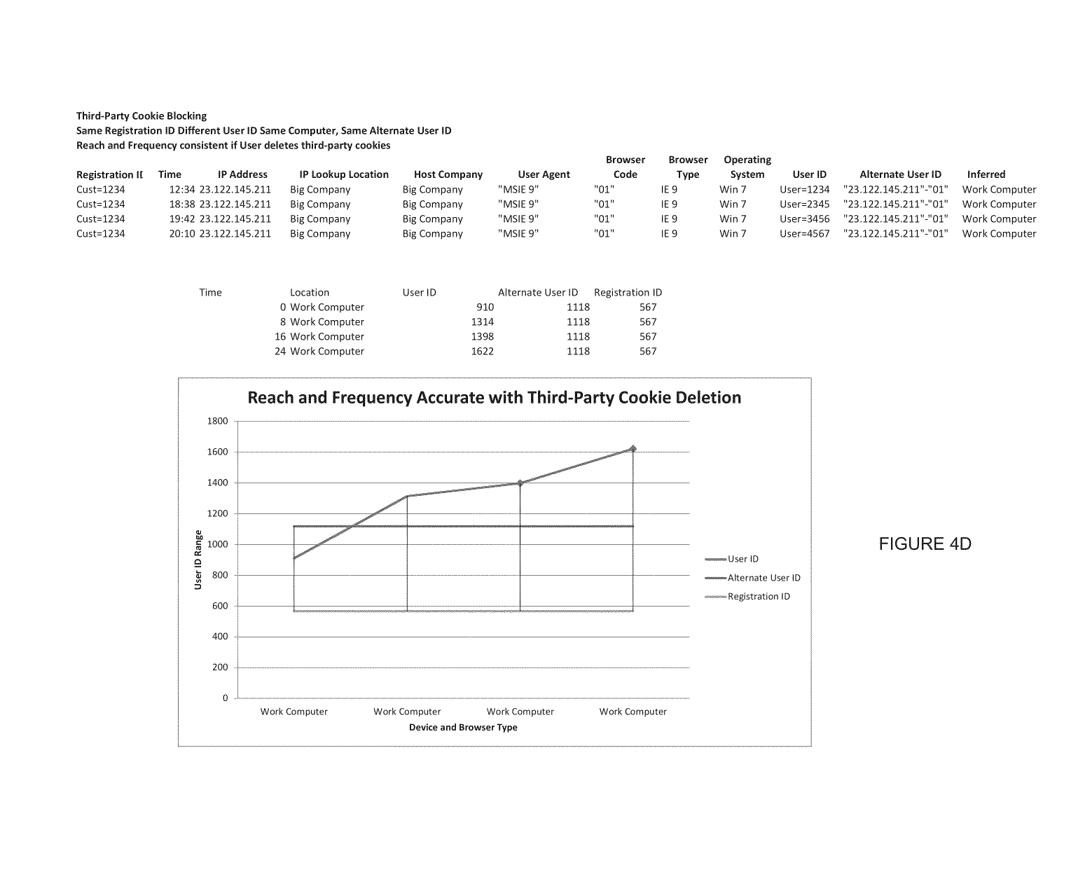

FIG. 3 provides a comparison of a first-party ad serving system to a third-party ad serving system. A distinction between first party and third party systems is that a first-party ad server (550) acts on behalf of the advertiser (600) and can read and write cookies in the advertiser domain (Domain1.com) or sub-domain (ad.Domain1.com). In the third-party ad serving model the third-party ad server (850) sets cookies in their own domain (Domain3.com) and does not work on behalf of the advertiser (900). Third-party cookie ad servers are targeted by many anti-spyware programs for deletion and are susceptible third-party cookie blocking and rejection in browsers.

The methods described herein facilitate the workflows of the individual players as well as the workflows between and among the advertiser and/or agency, e.g., TPAS, and the publishers. A campaign reporting system includes users surfing the web, ads served to their browsers, cookies accepted, rejected or deleted by/from their browsers, a database that logs files with the associated user cookie and ad information and a reporting system that uses cookies to track users and report on the reach and frequency of those ads.

Within the user's browser there are privacy controls that enable the user to Reject all cookies, reject only third-party cookies, and/or accept all cookies. There are also anti-spam and spyware programs that identify third-party data collection cookies and schedule them for deletion.

Internet Ads are typically controlled by cookies placed on the browser and enable the ad serving company to control which ads are viewed by the user. Internet browsers continue to evolve and new devices continue to be introduced that can take advantage of internet access. Cookie-type functionality is also evolving into files and databases as evidenced, but not limited to, the growing popularity of companies using Adobe Flash™ Local Shared Objects and Microsoft Silverlight™ “Isolated Storage” capabilities. Generally accepted advertising principals like frequency of ad exposure can be applied through these technologies to ensure that the user isn't exposed to the same ad too often thus reducing the possibility of ad burn-out.

On the reporting side, the process of the ad being served captures the unique cookie ID along with other user system data (IP Address, Browser Type, etc.) and the ad information (ad name, campaign, site, width/height, site section, etc.). The log files are processed to generate reports to show how many ads were served and then the reach of those ads (unique users) and frequency of those ads to the users as well as the actions by the users (click through, purchase, etc.). Cookies can be used to control the reach and frequency of the ads to help optimize the mix and increase the ROI of the campaign. If cookies are rejected or deleted it makes the reach and frequency reporting less accurate because many new cookies are served and subsequently counted as first impressions and unique users. Third-party cookies tend to get rejected and/or deleted more often than first-party cookies. First-party cookie technology, however, can be used to produce more accurate reach and frequency reports and can extend the process to include additional attributes to make the process even more accurate.

An exemplary implementation (FIG. 3) may be understood in the context of a user visiting a website like Domain1.com that has a first-party advertising relationship with a first-party ad server. The first-party relationship enables the first-party ad server to read and write cookies in the first-party mode (ad.Domain1.com) to take advantage of relationship data that the advertising company may store in their cookies (ad.domain1.com=high_value) to serve relevant ads on their behalf. When the user visits the Domain1.com website and logs-in they receive a Domain1.com registration cookie (i.e. Domain1.com=RegID=1234). When the user then surfs the web and lands on a site where the first-party ad server is serving ads on behalf of Domain1.com, the first-party ad-server will receive the contents of the Domain1.com cookie jar and can take advantage of any data stored in the cookie on behalf of Domain1.com. In this scenario, the campaign served from the first-party ad-server may serve a specific ad to the user knowing that they are a registered high-value registered user of the advertiser site. If the user is concerned about online privacy they may have their browser set to:
1) reject all cookies;
2) reject only third-party cookies;
3) accept all cookies.

### Reject All Cookies

If the user rejects all cookies they will get sent a new cookie request every time from first-party the ad-server (ad.domain1.com) or Domain1.com and the first-party ad server log files will capture a new User_ID each time but construct the same Alt_User_ID as long as the user is logging in from a consistent IP Address and Browser. In this case it's possible to track that this user is returning and the ad server or advertiser could actually generate a report on user location, operating system and browser type and the amount of users that are not accepting or are regularly deleting cookies.

### Reject Only Third-Party Cookies

If the user rejects third-party cookies but accepts first-party cookies there are a few scenarios: 1) when the user visits the Domain1.com website the user will receive a first-party cookie. 2) When the user visits a different domain site the user will be viewed as a third-party and will be able to read the first-party Domain cookie (Ad.domain1.com) but any cookie writing will be rejected. The log files will capture a “new” cookie when the cookie is set on the first-party domain and continue to count accurately for each third-party ad serve on the external domain. If the external domain is the first time the user is seen, the Domain1.com cookie will not be set because it will be viewed as a third-party cookie to the external domain. This difference can be significant because if the cookies are set in the first-party domain (ad.Domain1.com) they can be read in the third-party domain (200) even if the browser is set to not accept third-party cookies. The log files will also be updated with new->old cookies and reach will be counted correctly in this scenario, making the first-party ad serving process more accurate for reporting and optimization purposes.

### Accept All Cookies

If the user accepts all cookies then the third-party ad serving and counting process and the first-party ad serving and counting process will be similar but there could be counting discrepancies when the user accesses the web from different locations or devices. For example, a user may login from work (110) and then surf the web and view ads and then go home, login and view ads on a separate computer (120), tablet (130), or smartphone (140). In this scenario the standard reach and frequency counting process would count a reach of 2 and a frequency of one even though the same ad was viewed on both systems and should be counted as a reach of one and frequency of two.

In various implementations, however, a first-party system using the Alt_User_ID would see different User_ID's and different Alt_User_ID's but the same Registration_ID and could link the user across locations (IP addresses) and systems (work computer, home computer, tablet or smartphone). In this scenario, an enhanced counting process could correctly count the reach and frequency while standard third-party counting techniques could be significantly different.

In various first-party implementations, a new reach and frequency counting process works in a first-party cookie mode and captures multiple data points to help counting accuracy whether the user has their browser set to accept or reject cookies, there is a cookie deletion action by a the user or an anti-spam/spyware system or they use different forms of access such as work computer, home computer, tablet and smartphone.

### Exemplary Operations

FIG. 1 depicts an example ad serving environment. In this implementation, an advertisement serving system works on behalf of an advertiser and generates ad tags that are then placed by a publisher advertising system into purchased media inventory. When a user surfs with their browser (150) to a web page, the web page can have many calls to different servers for content. When the ad tag is requested, the browser sends a request to the advertisement server (250) along with a number of headers. These headers help the browser and the hosting server determine the best way to provide the requested information. The user agent string is included in one of the headers provided from the browser. The user agent string from Microsoft Internet Explorer 9, by default, provides the following information to the server:
1) Application name and version (“Mozilla/5.0”)
2) Compatibility flag (“Compatible”)
3) Version Tokens (“MSIE 9.0”)
4) Platform Tokens (Windows NT 6.1″)
5) Trident Token (“Trident/5.0”) (User-Agent: Mozilla/5.0 (compatible; MSIE 9.0; Windows NT 6.1; Trident/5.0).
   In many browsers it is possible to change the user agent string but the user needs to be technically proficient or run a program to make the changes. In general, the vast majority of users don't know these use agent strings exist and will never change them. In a typical web surfing process a user will visit a webpage from one of their systems (work computer (110), home computer (120), tablet (130), smartphone (140), etc.) (100), a Publisher website (200) will send HTTP headers that may include ad tags which will direct the browser to send its HTTP header information to the Advertisement deployment server (250) and request an ad. Since the ad tag had the “Host: media.Domain1.com”, the browser will send along the user agent and any cookies in the cookie jar for Domain1.com which can be used for counting, reach and frequency calculations.

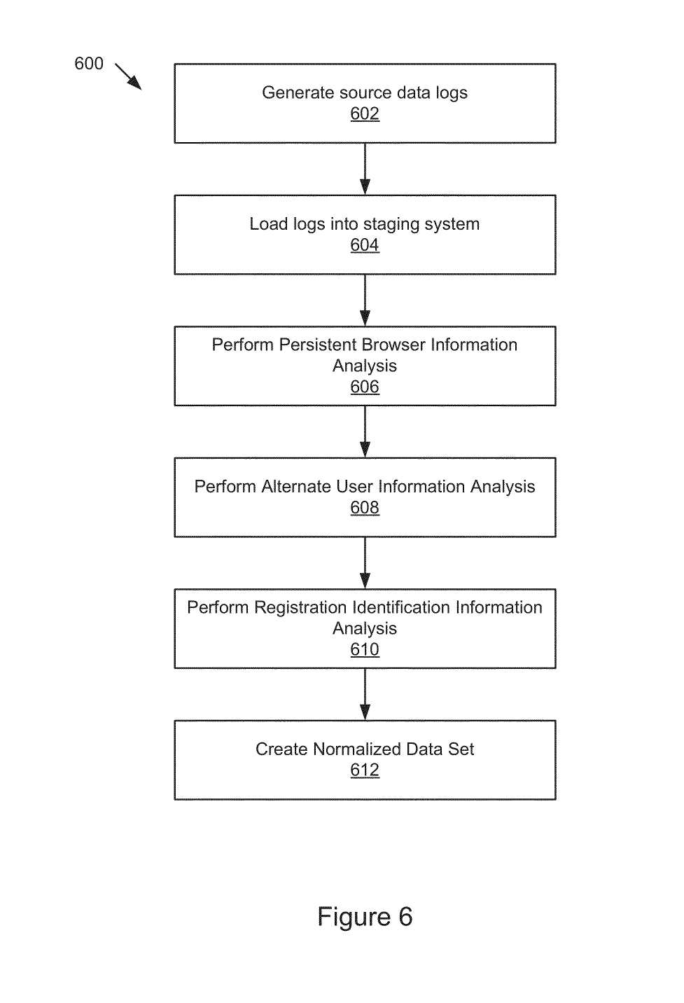

FIG. 6 shows example operations of a process 600 for determining data related to advertisement serving operations. The process 600, for example, may be performed to determine statistics such as, but not limited to, impression frequency, reach, site overlap, path analysis and the like. In the implementation shown in FIG. 6, for example, the process generates source data logs in operation 602. The source data logs, for example, may include all or a subset of transaction data collected in an advertisement serving process, such as for a campaign or within a particular domain. The transaction data, for example, comprises all or a subset of impressions, clicks, and pings. The data may further include name value pairs from the raw data. The source data logs can then be loaded into an analysis system, such as into staging tables, in operation 604. In one particular implementation, for example, the data is organized into sets for analysis. The sets, for example, may be organized around one or more advertising campaigns (e.g., by a campaign ID), an advertisement serving domain, such as for first party advertisement serving, (e.g., by a domain ID), around a start date, an end date and/or a date range, or by any other set organization useful for analysis.

The analysis system analyzes the source data logs (e.g., from the staging tables) in a variety of manners. In operation 606, for example, the analysis system performs the data analysis against a cookie, such as described above with respect to the standard new/old cookie paradigm. In operation 608, the analysis system performs data analysis against alternate user ID data (e.g., data that can be used to identify a user by browser or client device as described above). In operation 610, the analysis system performs data analysis against registration identification information (e.g., a Registration ID) that is readable and/or writeable in the first party domain space within a first party advertisement scheme.

The results of operation 606 are then compared to the results of operations 608 and/or 610 to create a normalized data set in operation 612. The normalized data set, for example, can be used to identify instances in which cookies (or other persistent browser information) may have been blocked or deleted. The normalized data, thus, provides improved measurement over standard new/old cookie analysis schemes.

It is important to note that either operation 608 or operation 610 may be performed in isolation or both operations 608 and 610 may be performed and the results compared to the results of operation 606. Thus, the results of a standard cookie analysis (operation 606) may be compared to an analysis performed using alternate user information (operation 608) and/or an analysis performed using registration identification information (operation 610).

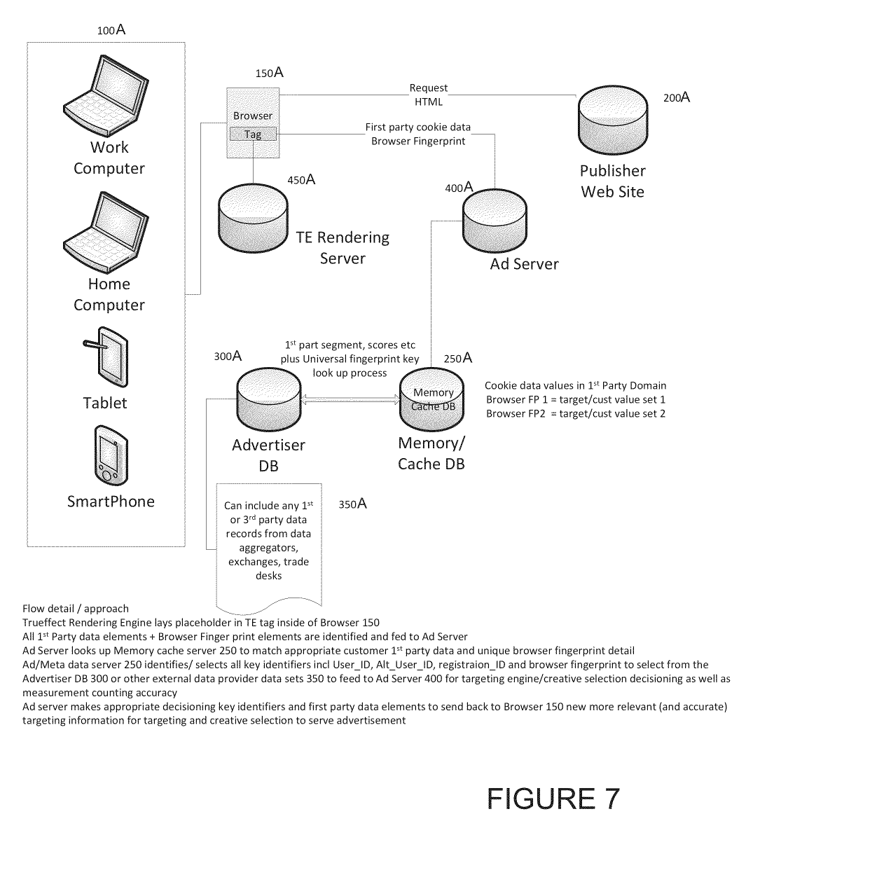

FIG. 7 shows an example implementation of an ad serving environment in which a plurality of identifiers are used in targeting an advertisement to be provided to a user. For example, the ad serving environment may use two or more of the user identifier, the alternate user identifier and the registration user identifier described herein as well as any number of other identifiers, including derivatives of those or other identifiers. In the example shown in FIG. 7, for example, one or more devices 100A, such as but not limited to the work computer, home computer, tablet and smart phone devices shown, connect to various web sites on a network (e.g., the Internet) via a browser 150A operating on the one or more devices 100A. The devices 100A, for example, may connect to a publisher web site 200A, an ad server web site 250A and/or an advertiser web site via the browser 150A.

In this particular example, a rendering engine executing on rendering server 450A provides a placeholder tag in the browser 150A of one or more of the devices 100A. First party information (cookie or other data elements), if present at the device 100A (e.g., in browser 150A), are identified and provided to an ad server 400A. The ad server 400A accesses memory cache server 250A (or other data storage device such as a database, disc storage or the like) to match one or more elements of the first party information and a unique (or semi-unique) browser fingerprint detail.

The memory cache server 250A and/or the ad server 400A identify and/or selects two or more identifiers, such as a user identifier, an alternate user identifier (e.g., a browser fingerprint) and/or a registration information identifier, to use to identify one or more advertisements from an advertiser database 300A or other external data provider data sets 350A to provide to the ad server 400A for targeting engine/creative selection decisioning as well as measurement counting accuracy. The ad server 400A determines whether to provide any additional or replacement identifiers and/or first party data elements back to the browser 150A to be used for relatively more relevant and/or accurate targeting information for targeting and creative selection to serve advertisements.

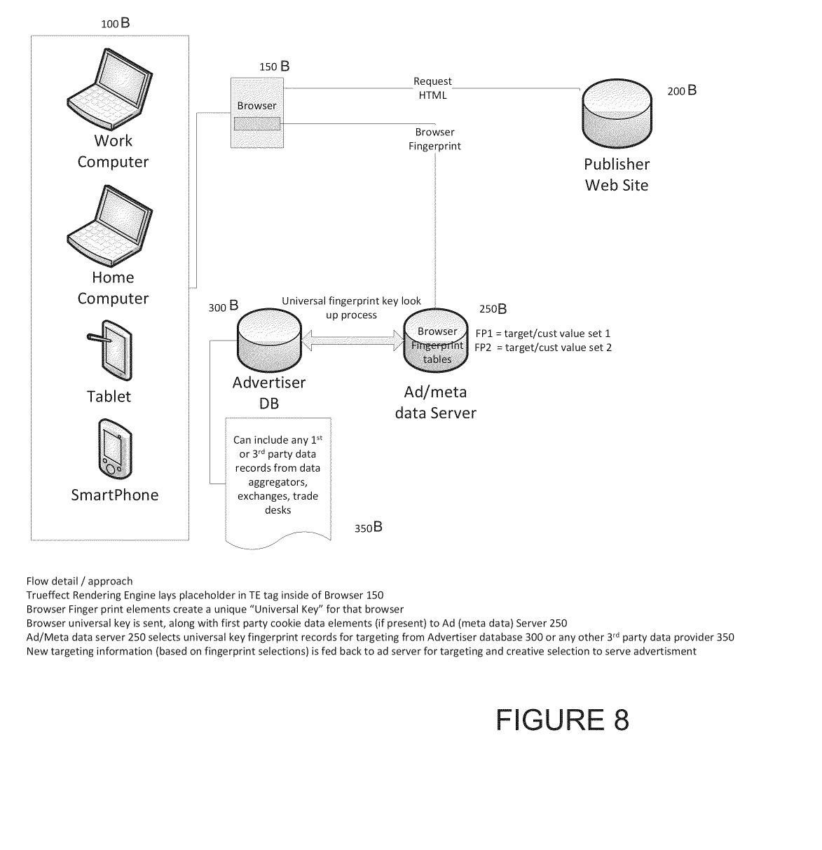

FIG. 8 shows another example implementation of an ad serving environment in which a browser and/or device fingerprint identifier is used in targeting an advertisement to be provided to a user. As described herein, the fingerprint identifier may be used alone or with one or more other identifiers. In the example shown in FIG. 8, for example, one or more devices 100B, such as but not limited to the work computer, home computer, tablet and smart phone devices shown, connect to various web sites on a network (e.g., the Internet) via a browser 150B operating on the one or more devices 100B. The devices 100B, for example, may connect to a publisher web site 200B, an ad server web site 250BA and/or an advertiser web site via the browser 150B.

In this particular example, a rendering engine executing on rendering server provides a placeholder tag in the browser 150B of one or more of the devices 100B as described above with respect to FIG. 7. Browser and/or device fingerprint elements are used to create a unique (or semi-unique) fingerprint key (e.g., a universal key) for the browser 150B and/or device 100B. The fingerprint key, for example, may be stored in the browser 150B or the elements may be provided to an ad/meta data server 250B, which can use the elements to create on or more keys for use in an ad serving process. The fingerprint key may be a universally unique key or sufficiently distinct to statistically sufficiently distinguish a wide sampling of devices and/or browsers for the purpose of serving ads.

In addition to the fingerprint key or fingerprint elements, first party data elements (e.g., cookie or other data), if present, may be forward to the ad/meta data server 250B as well. The ad/meta data server 250B selects universal key or fingerprint key records for targeting from an advertiser database 300B or from any other third party data provider 350B. New targeting information (e.g., based on fingerprint selections) is provided back to the ad server 250B for targeting and creative selection to serve an advertisement as well as for measurement determination. As described above with respect to FIG. 7, the ad server 250B may also determine whether to provide any additional information such as identifiers and/or first party data elements back to the browser 150B to be used for relatively more relevant and/or accurate targeting information for targeting and creative selection to serve advertisements.

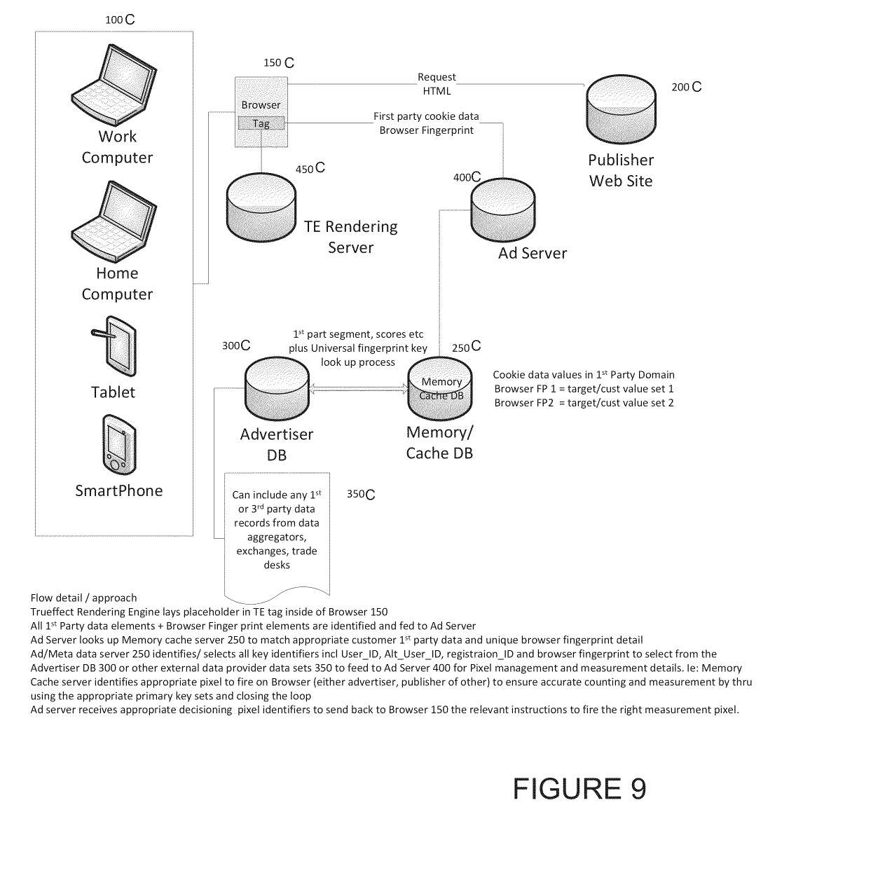

FIG. 9 shows another example implementation of an ad serving environment in which a pixel firing measurement is performed. In the example shown in FIG. 9, for example, one or more devices 100C, such as but not limited to the work computer, home computer, tablet and smart phone devices shown, connect to various web sites on a network (e.g., the Internet) via a browser 150C operating on the one or more devices 100C. The devices 100C, for example, may connect to a publisher web site 200C, an ad server web site and/or an advertiser web site via the browser 150C.

In this particular example, a rendering engine executing on rendering server 450C provides a placeholder tag in the browser 150C of one or more of the devices 100C. First party information (cookie or other data elements), if present at the device 100C (e.g., in browser 150C), are identified and provided to an ad server 400C. Browser and/or device fingerprint elements are also identified and provided to the ad server 400C. The ad server 400C accesses memory cache server 250C (or other data storage device such as a database, disc storage or the like) to match one or more elements of the first party information and a unique (or semi-unique) browser fingerprint detail. As described above, the fingerprint key or detail may be a universally unique key or sufficiently distinct to statistically sufficiently distinguish a wide sampling of devices and/or browsers for the purpose of serving ads.

The memory cache server 250C and/or the ad server 400C identify and/or select one or more identifiers, such as a user identifier, an alternate user identifier (e.g., a browser fingerprint) and/or a registration information identifier, to use to identify one or more advertisements from an advertiser database 300C or other external data provider data sets 350C to provide to the ad server 400C for pixel management and measurement details. For example, memory cache server 300C can identify appropriate pixel(s) to fire on a browser 150C (either advertiser, publisher, or other) to ensure accurate counting and measurement via using an appropriate primary key set and closing a loop. The ad server 400C receives decisioning pixel identifiers to send back to the browser 150C one or more instructions to fire one or more determined measurement pixel(s).

### Exemplary Computing System

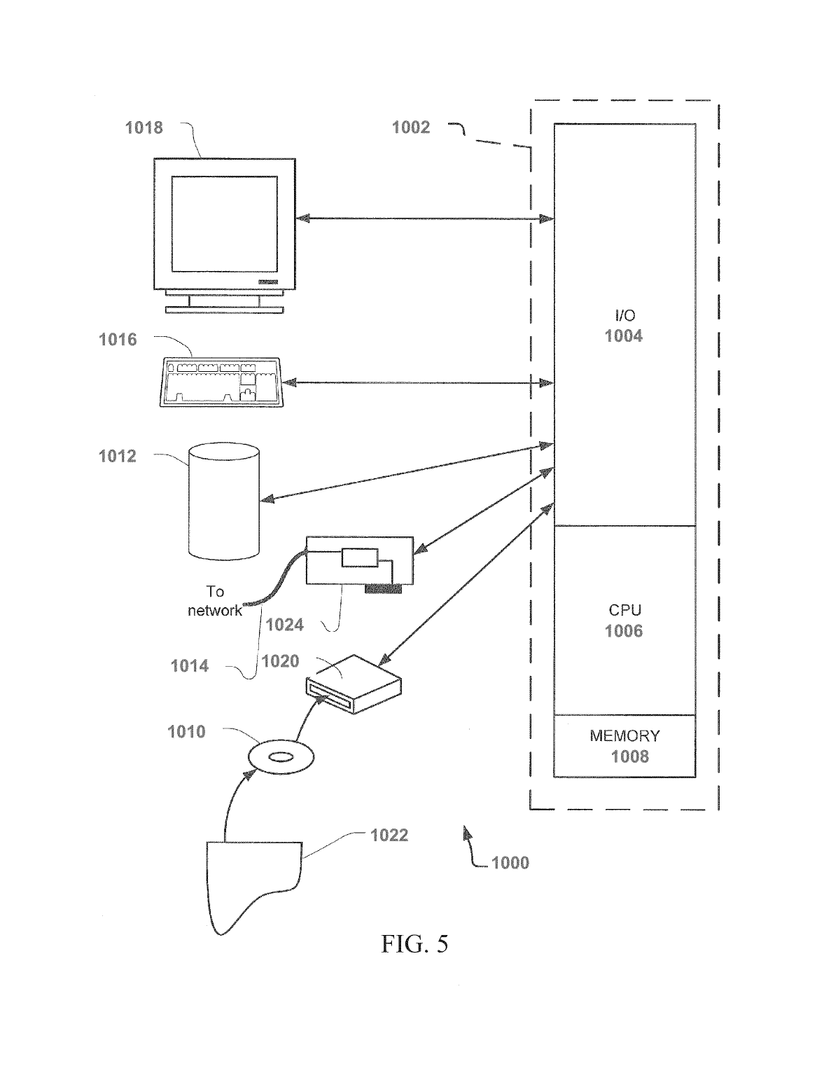

FIG. 5 is a schematic diagram of a computing device 1000 upon which a creatives management or deployment system may be implemented. As discussed herein, implementations include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

FIG. 5 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 5 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 5 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other storage medium units coupled to the computer system. Said software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of the computer system being used. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

In some implementations, articles of manufacture are provided as computer program products. One implementation of a computer program product provides a transitory or non-transitory computer program storage medium readable by a computer system and encoding a computer program. Another implementation of a computer program product may be provided in a computer data signal embodied in a carrier wave by a computing system and encoding the computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

We claim:

1. A method comprising:
receiving persistent browser information from a client system at an adserver, wherein the persistent browser information is set within a domain of an advertiser and the adserver is operating within the domain of the advertiser;
receiving at least one of (i) system information related to the client system and (ii) registration information related to a user of the client system from the domain of the advertiser; and
determining advertising metrics based on the persistent browser information and at least one of the of (i) the system information and (ii) the registration information.

2. The method of claim 1 wherein the adserver is operating within a delegated sub-domain of the advertiser.

3. The method of claim 1 wherein the metrics comprise at least one of reach and frequency.

4. The method of claim 1 wherein the at least one of the (i) the system information and (ii) the registration information is captured.

5. The method of claim 4 wherein the at least one of the (i) the system information and (ii) the registration information is written to a log file.

6. The method of claim 1 wherein the at least one of the (i) the system information and (ii) the registration information is associated with the persistent browser information.

7. The method of claim 6 wherein the at least one of the (i) the system information and (ii) the registration information is associated with the persistent browser information in a log file.

8. The method of claim 1 wherein the system information comprises at least one of a device identifier, a location identifier, an operating system, a browser identifier, a browser brand, a browser version, an Internet Protocol address, a MAC address.

9. The method of claim 1 wherein the registration information comprises registration information of a user to a system associated with the domain of the advertiser.

10. The method of claim 1 further comprising updating the persistent browser information

11. The method of claim 10 wherein the updated persistent browser information comprises an updated cookie.

12. The method of claim 11 wherein the updated cookie is written to browser files for storage.

13. The method of claim 10, wherein the persistent browser information comprises at least one of browser Local Shared Objects, Adobe Flash, Microsoft Silverlight, HTML5, Javascript, or the like.

14. The method of claim 1 wherein the persistent browser information comprises a cookie.

15. The method of claim 1 wherein the persistent browser information comprises a first-party browser cookie.

16. The method of claim 1 wherein the persistent browser information is used to identify a user on a computer system using information obtained from within the domain of the advertiser.

17. The method of claim 1 wherein the metrics comprise at least one of path analysis; site performance of the site where ad inventory was purchased; and media performance of a specific media type.

18. The method of claim 17 wherein the metrics provide a closed-loop tracking system that enables the advertiser to track multiple ad exposure to actions taken on the advertiser site enabling media attribution.

19. The method of claim 1 wherein a user is identified using a value calculated from an IP address collected by the adserver and a user-agent string provided by an HTTP header GET request from a browser to a server.

20. The method of claim 19 wherein the calculated value is compared to a registration value for an advertiser to identify the user across at least one of multiple access devices and multiple access locations.

21. The method of claim 20 wherein the calculated value is compared to the registration value to further serve an ad to the identified user and to report on the user across at least one of multiple access devices and multiple access locations.

22. The method of claim 1 wherein a user is identified in the domain of the advertiser by an adserver operating within a delegated sub-domain of the advertiser based on at least one of a registration-based browser cookie, a registration-based browser file, and a registration-based browser database.

23. The method of claim 1 wherein the persistent browser information comprises a cookie set within the domain of the advertiser by a registration system on which a user creates an account or logs in.

24. The method of claim 23 wherein the registration information comprises an advertiser registration-type identifier.

25. The method of claim 24 wherein the registration information is compared against an ad server user identifier to determine the existence of multiple ad server user identifiers for a single registration-type identifier on a single device.

26. The method of claim 25 wherein a report generated based on the registration information identifies whether the persistent browser information is being at least one of blocked and deleted by the user.

27. The method of claim 24 wherein the registration information is compared against an ad server alternate user identifier to validate an existence of multiple user locations or connection addresses within a single location for a single registration-type ID.

28. The method of claim 24 wherein the registration information is compared against an ad server alternate user identifier to report on an existence of multiple user devices for a single registration-type identifier.

29. The method of claim 24 wherein the registration information is compared against an ad server user identifier and an alternate user identifier to produce a path analysis.

30. The method of claim 29 wherein the path analysis is used to identify at least one of a device, a a location and a time-of-day for which the user or a community of users is relatively likely to review and subsequently purchase products.

31. The method of claim 24 wherein the registration information is compared against the ad server user ID and alternate user ID to produce path analysis reports to understand the reach and frequency of ad exposures across at least one of devices, locations and times-of-day for a user or community of users.

32. The method of claim 24 wherein the advertising metrics are analyzed to determine relatively efficient or effective advertiser sites, devices and media types and offer types.

33. The method of claim 25 wherein the media types comprise at least one of rich media, video, expandables, banner advertisements, email advertisements.

34. The method of claim 24 wherein the registration information is used to identify a user that deletes cookies by comparing a user identifier with an alternative user identifier not stored in a cookie.

35. The method of claim 34 wherein the operation of identifying the user that deletes cookies further comprises comparing the user identifier with a registration identifier assigned by a secondary system.

36. The method of claim 35 further comprising generating a report identifying (i) reach and frequency information, (ii) a user path analysis, and (iii) user access system variability and preference.

37. The method of claim 1 wherein the registration information comprises information set within the domain of the advertiser by a registration system.

38. A system comprising:
an adserving server configured to:
receive persistent browser information from a client system, wherein the persistent browser information of the client system is set within a domain of an advertiser and the adserving server is operating within the domain of the advertiser;
receive at least one of (i) system information related to the client system and (ii) registration information related to a user of the client system from the domain of the advertiser; and
determine advertising metrics based on the persistent browser information and at least one of the of (i) the system information and (ii) the registration information.
